(19) United States
(12) Patent Application Publication
(10) Pub. No.: US 2006/0102291 A1
(43) Pub. Date: May 18, 2006

(54) Label sticking apparatus

(75) Inventor: Ryuji Hongo, Tokyo (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: LINTEC CORPORATION, Tokyo (JP)

(21) Appl. No.: 11/270,652

(22) Filed: Nov. 10, 2005

(30) Foreign Application Priority Data
Nov. 16, 2004 (JP) 2004-332456

(51) Int. Cl. B65C 9/18

(52) U.S. Cl. 156/542

(57) ABSTRACT

A rotation-driven drive roller 16 and plural (two) pinch rollers 17 and 18 are arranged so as to pinch a release liner 3 to pay out the release liner 3 intermittently, and labels L temporarily stuck on the release liner 3 are peeled off and stuck to an object. The pinching force of the pinch roller 18 at the downstream side in pay-out direction of the release liner 3 is set to be smaller than that of the pinch roller 17 at the upstream side. am side.

### BACKGROUND OF THE INVENTION

1. Field of the Invention

The present invention relates to a label sticking apparatus that peels off labels temporarily stuck on a release liner and sticks automatically the label to an object to be stuck with the same.

2. Description of the Related Art

As a label sticking apparatus, which sticks automatically labels to the object transferred continuously one after another by means of conveyance such as a belt conveyor, as shown in FIG. 8, there is known a label sticking apparatus which pinches a release liner 103 with a rotation-driven drive roller 116 and a pinch roller 117 performing pressure-contact with the drive roller 116 to pay out the release liner 103 intermittently, and the release liner 103 is bent at a sharp angle by a peel plate 112 to peel off labels L, which are temporarily stuck on the release liner 103, and the peeled label L is stuck onto an object to be stuck with the label H (for example, refer to patent document 1 (Japanese Patent Application Laid-Open No. 2001-278233) and patent document 2 (Japanese Patent Application Laid-Open No. 2004-210455)).

However, in the conventional label sticking apparatus shown in FIG. 8, since only one pinch roller 117 is provided, following problems have been found.

That is, in the label sticking apparatus, which repeats the operation of rotating and stopping; i.e., performs the operation of intermittent rotation, a single pinch roller 117 causes such a problem that slack T, at a portion of the release liner 103 winding on the drive roller 116 as shown in FIG. 8, is generated on a stoppage of the drive roller 116, in case where the drive roller 116 is rotated intermittently at a high speed for sticking performance enhancement. As a result, gripping force of the release liner 103 is reduced. Therefore, even when the next paying out operation is performed, the release liner 103 can not be paid out in succession due to slippage. Thus, it becomes impossible that the label L is paid out at proper timing to stick correctly to the object H. Such problem is caused by inertia, elongation or the like of release liner 103 on paying out the label L.

### SUMMARY OF THE INVENTION

The invention has been proposed in view of the above problem. The object of the invention is to provide a label sticking apparatus, which is, even when a drive roller is rotated intermittently at high speed for sticking performance enhancement, capable of preventing slippage of a release liner due to insufficient pinching force and is capable of paying out the label at predetermined timing to stick the same correctly.

To achieve the object, the invention set forth in claim 1 is a label sticking apparatus, in which a rotation-driven drive roller and a pinch roller performing a pressure-contact with the drive roller pinches a release liner to pay out the release liner intermittently, and labels stuck temporarily on the release liner are peeled off and stuck to an object, comprising a plurality of said pinch rollers.

The invention set forth in claim 2 is the label sticking apparatus according to claim 1, wherein the pinching force of the pinch roller at the downstream side in pay-out direction of the release liner is set to be smaller than that of the pinch roller at the upstream side.

The invention set forth in claim 3 is the label sticking apparatus according to claim 1 or 2, wherein each of the pinch rollers is arranged to be able to contact with and keep apart from the drive roller.

The invention set forth in claim 4 is the label sticking apparatus according to claim 1, 2 or 3, wherein each of the pinch rollers is supported rotatably by a swing arm so as to be able to swing and is arranged to be pressed toward the drive roller by a pressing device so as to perform pressure-contact therewith.

The invention set forth in claim 5 is the label sticking apparatus according to claim 4, wherein the pressing device is formed of a spring, and the spring constant of the spring for pressing the pinch roller at the downstream side in the pay-out direction of the release liner is set to be smaller than that of the spring for pressing the pinch roller at the upstream side.

According to the invention, a plurality of pinch rollers are provided for pinching the release liner between the drive roller and the pinch rollers. Therefore, the contact area of the release liner with the drive roller is increased, which enables the drive roller to pay out the release liner reliably. Accordingly, even when the drive roller is rotated intermittently at a high speed for sticking performance enhancement, slippage of the release liner due to insufficient pinching force is prevented; thus the label can be paid out at predetermined timing and stuck to the object correctly.

Further, according to the invention, the pinching force of the pinch roller at the downstream side in pay-out direction of the release liner is set to be smaller than that of the pinch roller at the upstream side. Therefore, slack of the release liner generated between a plurality of pinch rollers is absorbed. Accordingly the release liner is constantly paid out stably.

### BRIEF DESCRIPTION OF THE DRAWINGS

FIG. 1 is a plan view of a label sticking apparatus in accordance with the invention,

FIG. 2 is an enlarged plan view of a principal part of the label sticking apparatus in accordance with the invention,

FIG. 3 is a side view of a principal part of the label sticking apparatus in accordance with the invention,

FIG. 4 is a sectional view taken along the line A-A in FIG. 2,

FIG. 5 is a sectional view taken along the line B-B in FIG. 2,

FIG. 6 is an illustration taken along the line C-C viewed from the direction indicated with the arrows in FIG. 5,

FIG. 7 is a perspective view of a portion of a drive roller and a pinch roller of the label sticking apparatus in accordance with the invention, and

FIG. 8 is a schematic plan view showing an arrangement of an principal part of a conventional label sticking apparatus.

### DETAILED DESCRIPTION OF THE PREFERRED EMBODIMENT

Hereinafter, an embodiment of the invention will be described with reference to the accompanying drawings.

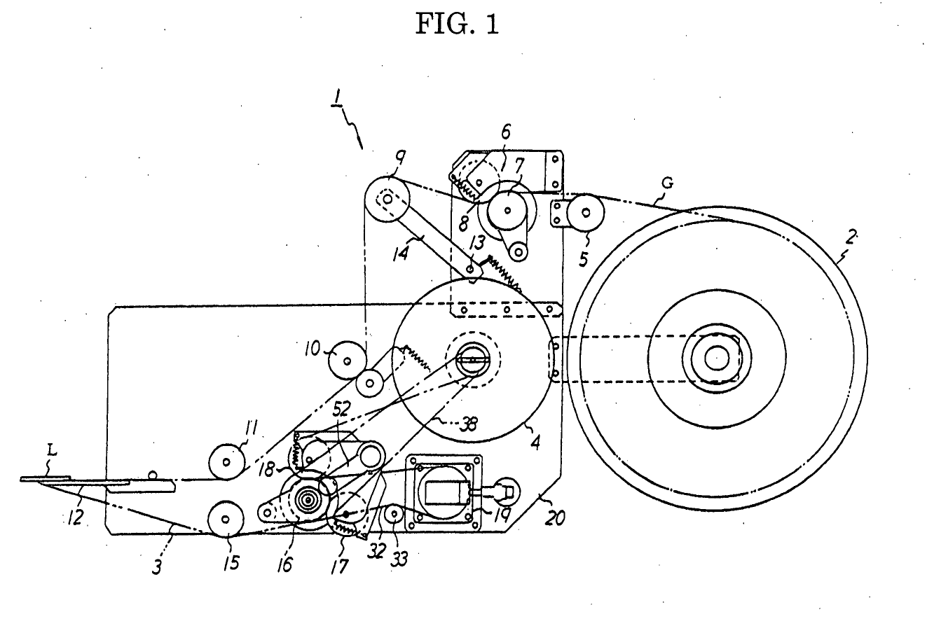

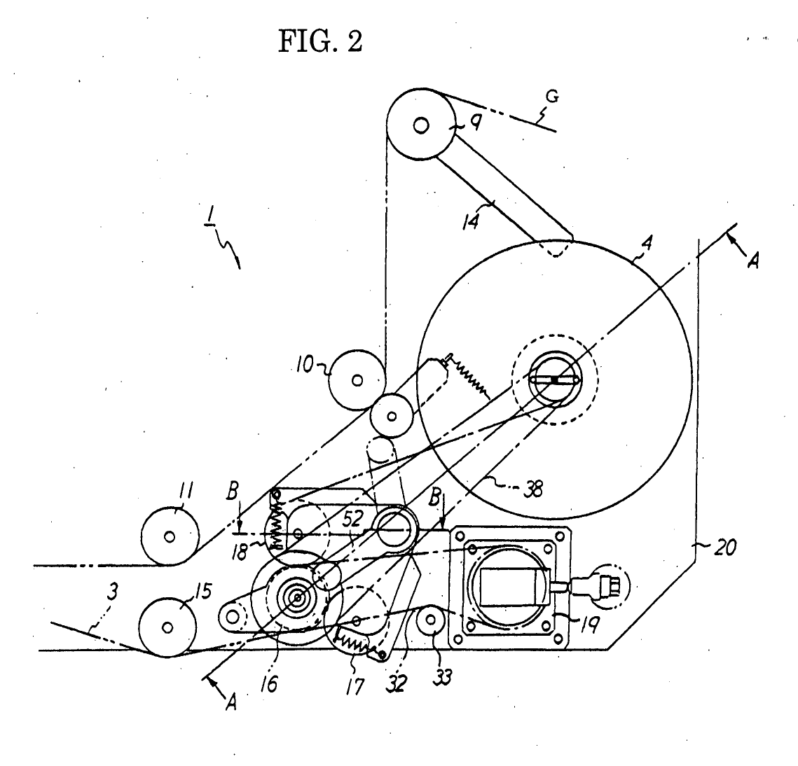

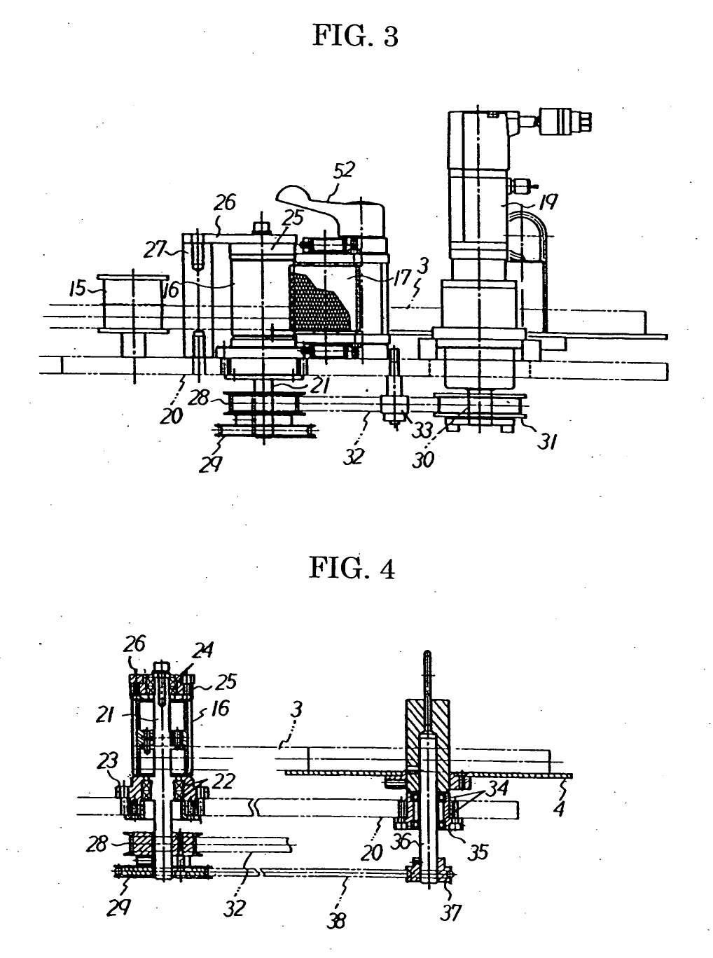

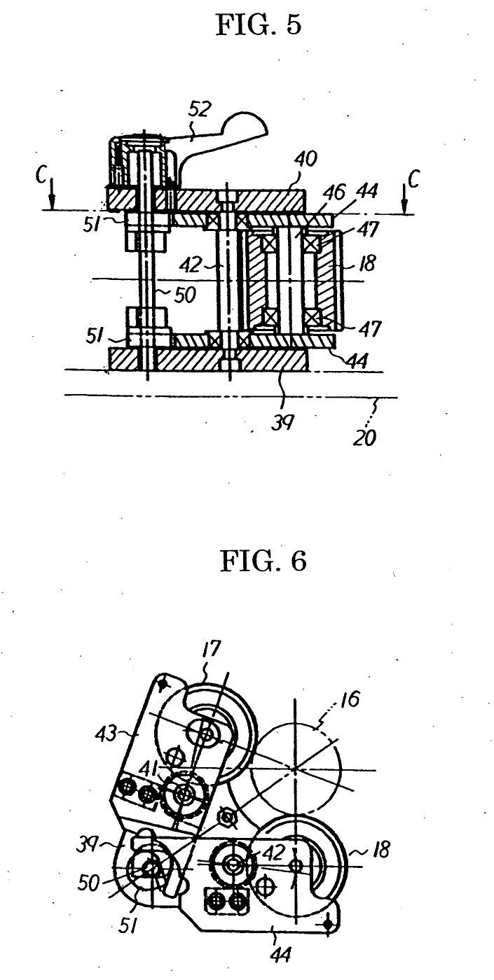

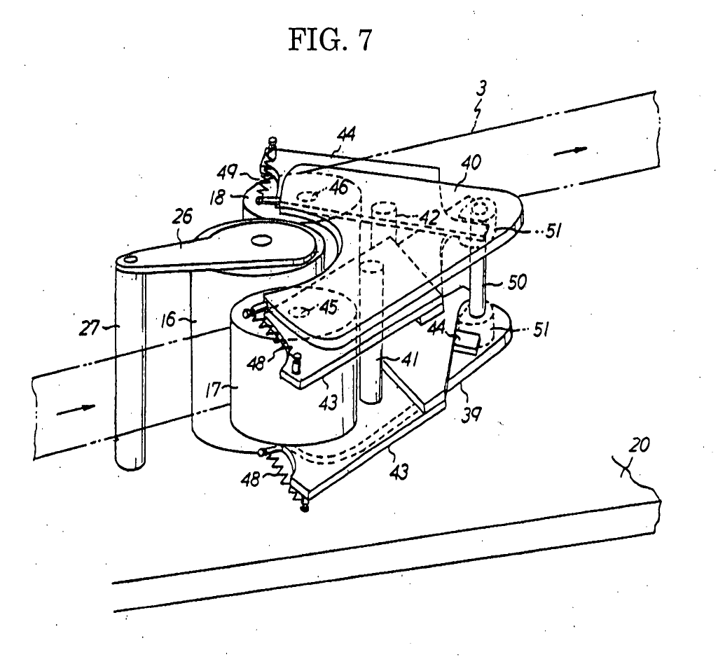

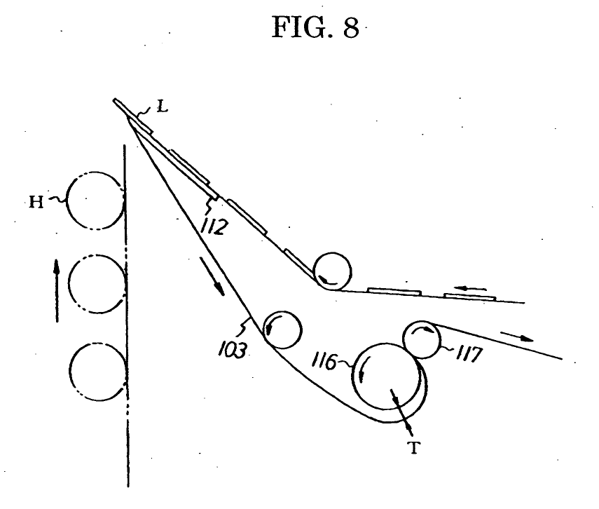

FIG. 1 is a plan view of a label sticking apparatus in accordance with the invention, FIG. 2 is an enlarged plan view of the principal part of the label sticking apparatus, FIG. 3 is a side view of the principal part of the label sticking apparatus, FIG. 4 is a sectional view taken along the line A-A in FIG. 2, FIG. 5 is a sectional view taken along the line B-B in FIG. 2, FIG. 6 is an illustration taken along the line C-C viewed from the direction indicated with the arrows in FIG. 5 and FIG. 7 is a perspective illustration of drive roller and pinch roller portion.

In the label sticking apparatus 1 shown in FIG. 1, reference numeral 2 denotes a pay-out reel with a label sheet G wound in a roll shape, in which plural labels L are temporarily stuck at predetermined intervals on a release liner 3, reference numeral 4 denotes a winding reel for winding the release liner 3 after the labels are peeled off. The pay-out reel 2 and the winding reel 4 are supported rotatably in the horizontal direction. In the path of the release liner 3 between paying out spot by the pay-out reel 2 and winding spot by the winding reel 4, a group of various rollers are disposed.

That is, in the direction where a label sheet G is paid out from the pay-out reel 2, a guide roller 5 and an unwinder 6 are disposed. The unwinder 6 is a unit that pinches the label sheet G being wound on the pay-out reel 2 with a drive roller 7 and a pinch roller 8 pressed against the drive roller 7, and pays out the label sheet G intermittently. The drive roller 7 is rotated intermittently at predetermined timing by a motor not shown.

The label sheet G paid out from the unwinder 6 runs around a tension roller 9, guide rollers 10 and 11 down to a peel plate 12. The tension roller 9 is supported rotatably at the end portion of an arm 14, which can horizontally swing around the axis 13 as a center, and pulls constantly the label sheet G laid between the tension roller 9 and the peel plate 12 so as to impart a predetermined tension thereto.

Another guide roller 15 is disposed at a position opposite to the guide roller 11. The label sheet G, which is turned back at a sharp angle by the peel plate 12, goes to the drive roller 16 through the guide roller 15. When the label sheet G is bent sharply by the peel plate 12, the label L is peeled off from the release liner 3. The peeled labels L are automatically stuck to the objects (not shown) successively. As described above, the release liner 3, from which the labels L have been peeled off, goes to the drive roller 16 through the guide roller 15.

Here, two pinch rollers 17 and 18 are pressed against the drive roller 16. When the drive roller 16 is intermittently rotated at predetermined timing by the motor 19, the release liner 3 pinched by the drive roller 16 and two pinch rollers 17, 18 is paid out toward the winding reel 4 and wound by the same. The winding reel 4 is also rotated at predetermined timing by the motor 19 to wind the release liner 3, which will be described later.

Now, the drive roller 16 and the pinch rollers 17, 18, which are constituting the core part of the invention will be described.

As shown in FIG. 4, the drive roller 16 is attached to a rotary shaft 21 supported by a faceplate 20 rotatably. That is, the rotary shaft 21 is inserted vertically through the faceplate 20, and the middle area thereof is supported rotatably by the faceplate 20 via a bearing 22 and a bearing block 23. The upper end portion of the rotary shaft 21 is rotatably supported by one end of a plate 26 via a bearing 24 and a bearing block 25. As shown in FIG. 3 and FIG. 7, the other end of the plate 26 is attached to the upper end of a shaft 27 vertically provided on the faceplate 20.

As shown in FIG. 3 and FIG. 4, in an extended portion of the rotary shaft 21 coming through the faceplate 20 downwardly, a small diameter pulley 28 and a large diameter pulley 29 are attached in up-down double step disposition.

On the other hand, the motor 19 as a driving unit is fixed vertically on the faceplate 20. As shown in FIG. 3, in an extended portion of the output shaft 30 of the motor 19 coming through the faceplate 20 downwardly, a pulley 31 is attached. The pulley 31 and the pulley 28 fixed to the rotary shaft 21 of the drive roller 16, are provided with an endless belt 32, which is laid around the pulleys. A tension roller 33 is provided to abut against the belt 32. The tension roller 33 imparts a predetermined tension to the belt 32.

As shown in FIG. 4, the winding reel 4 is attached to a rotary shaft 36, which is rotatably supported by the faceplate 20 via a bearing 34 and a bearing block 35. In an extended portion of the rotary shaft 36 coming through the faceplate 20 downwardly, a pulley 37 is attached. An endless round belt 38 is laid around the pulley 37 and the pulley 29 fixed to the rotary shaft 21 of the drive roller 16.

On the other hand, as shown in FIG. 5 and FIG. 7, a fixed plate 39 is fixed to the faceplate 20. And above the fixed plate 39, a fixed plate 40 having an equivalent shape of the fixed plate 39 is supported parallel therewith by two shafts 41, 42. Pairs of upper and lower swing arms 43 and 44 are arranged to have each pivot shaft 41 and 42 at the middle portion thereof so as to swing respectively. The end portions of the swing arms 43 and 44 support the pinch rollers 17 and 18 in rotatable manner respectively. That is, each of the pinch rollers 17 and 18 is supported rotatably by shaft 45 and 46 vertically bridged between the pair of upper and lower swing arms 43 and 44 via a pair of upper and lower bearings 47 (in FIG. 5, only the pinch roller 18 is shown).

Also, as shown in FIG. 7, between each end portion of the upper and lower swing arms 43 and each end portions of the upper and lower fixed plates 39 and 40, springs 48 are provided for compression as the pressing devices. Owing to these springs 48, the pinch roller 17 is pressed toward the drive roller 16 around the shaft 41 as a center to perform pressure-contact with the periphery of the drive roller 16 at a predetermined pinching force. Likewise, also between each end portion of the upper and lower swing arms 44 and the each end portion of the upper and lower fixed plates 39 and 40, springs 49 are provided for compression as pressing devices. Owing to these springs 49, the pinch roller 18 is pressed toward the drive roller 16 around the shaft 42 as a center to perform pressure-contact with the periphery of the drive roller 16 at a predetermined pinching force.

Here, the release liner 3 is laid around the drive roller 16 and the two pinch rollers 17 and 18 as shown. The release liner 3 is pinched by these drive roller 16 and the pinch rollers 17 and 18 to be paid out in the direction indicated with the arrows in FIG. 7. The pinching force (pressure-contact force) of the pinch roller 18 at the downstream side in the pay-out direction is set to be smaller than the pinching force of the pinch roller 17 at the upstream side. Specifically, the spring constant of the springs 49 for pressing the pinch roller 18 at the downstream side is set to be smaller than the spring constant of the springs 48 for pressing the pinch roller 17 at the upstream side.

As shown in FIGS. 5 to 7, between the end portions of the pair of upper and lower fixed plates 39 and 40, a vertical shaft 50 is supported rotatably. At the upper and lower portions of the shaft 50, cams 51 are fixed, and each of the cams 51 is engaged with each end portion of the swing arms 43 and 44. At the upper end of the shaft 50, a lever 52 is fixed (refer to FIG. 2, FIG. 3 and FIG. 5). When the lever 52 is turned to a position as indicated by a broken line in FIG. 2, the cams 51 fixed with the lever 52 turn the swing arms 43 :and 44 around the axes 41 and 42 as centers respectively, enabling the pinch rollers 17 and 18 to keep apart from the drive roller 16 simultaneously.

Consequently, when the motor 19 is driven at predetermined timing in accordance with control signals from a control unit (not shown), the rotation of the output shaft 30 is transmitted to the rotary shaft 21 of the drive roller 16 via the pulley 31, the belt 32 and the pulley 28, and the rotary shaft 21 and the drive roller 16 attached thereto are rotated at a predetermined speed. Owing to the rotation of the drive roller 16, the release liner 3 pinched by the drive roller 16 and the two pinch rollers 17 and 18, which abut against the drive roller and rotate as followers, is paid out toward the winding reel 4.

Also, the rotation of the rotary shaft 21 of the drive roller 16 is transmitted to the rotary shaft 36 via the pulley 29, the round belt 38 and the pulley 37, and the rotary shaft 36 and the winding reel 4 fixed thereto is rotated at a predetermined speed. Thus, the release liner 3 paid out by the drive roller 16 and the pinch rollers 17 and 18 are wound by the winding reel 4.

As described above, according to the embodiment, two pinch rollers 17 and 18 are provided to perform pressure-contact with the drive roller 16, and the drive roller 16 and the pinch rollers 17, 18 are arranged so that the release liner 3 is paid out being pinched therebetween. Therefore, the contact area of the release liner 3 with the drive roller 16 is enlarged to increase the frictional force therebetween. Accordingly, the drive roller 16 pays out the release liner 3 reliably. Even when the drive roller 16 is rotated intermittently at a high speed for the sticking performance enhancement, the slippage of the release liner 3 due to insufficient pinching force is prevented; thus, the label can be paid out at predetermined timing and stuck to the object correctly.

Further, according to the embodiment, the pinching force of the pinch roller 18 at the downstream side in the feed out direction of the release liner 3 is arranged to be smaller than that of the pinch roller 17 at the upstream side. Accordingly, the slack of the release liner 3 generated between the two pinch rollers 17 and 18 is absorbed. Thus, the release liner 3 is constantly paid out in stable condition.

Although two pinch rollers are provided in the embodiment, three or more pinch rollers may be provided. In such case, by setting the pinching force of the pinch rollers at the downstream side in the pay-out direction of the release liner to be smaller than that of the pinch roller at the upper stream side, the slack of the release liner generated between the plural pinch rollers can be absorbed.

### INDUSTRIAL AVAILABILITY

The invention is useful for a label sticking apparatus, which peels off labels temporarily stuck on a release liner and sticks the label to an object automatically.

1. A label sticking apparatus, in which a rotation-driven drive roller and a pinch roller performing a pressure-contact with the drive roller pinches a release liner to pay out the release liner intermittently, and labels stuck temporarily on the release liner are peeled off and stuck to an object, comprising
a plurality of said pinch rollers.

2. The label sticking apparatus according to claim 1, wherein the pinching force of the pinch roller at the downstream side in pay-out direction of said release liner is set to be smaller than that of the pinch roller at the upstream side.

3. The label sticking apparatus according to claim 1 or 2, wherein each of said pinch rollers is arranged to be able to contact with and keep apart from said drive roller.

4. The label sticking apparatus according to claim 1 or 2, wherein each of said pinch rollers is supported by a swing arm so as to be able to swing and is arranged to be pressed toward said drive roller by a pressing device so as to perform pressure-contact therewith.

5. The label sticking apparatus according to claim 4, wherein said pressing device is formed of a spring, and the spring constant of the spring for pressing the pinch roller at the downstream side in pay-out direction of the release liner is set to be smaller than that of the spring for pressing the pinch roller at the upstream side.
